(19) United States
(12) Patent Application Publication
(10) Pub. No.: US 2019/0315287 A1
(43) Pub. Date: Oct. 17, 2019

(54) CUP HOLDER STRUCTURE WITH INTEGRATED ELECTRONIC DEVICE HOLDER

(71) Applicant: Calsonic Kansei North America, Inc., Farmington Hills, MI (US)

(72) Inventors: BRIAN BOBER, West Bloomfield, MI (US); Janiece-Mattice Bober, West Bloomfield, MI (US)

(21) Appl. No.: 16/185,901

(22) Filed: Nov. 9, 2018

Related U.S. Application Data
(60) Provisional application No. 62/658,197, filed on Apr. 16, 2018.

(51) Int. Cl. B60R 11/02; B60N 3/10

(52) U.S. Cl. CPC B60R 11/0241; B60R 2011/0007; B60N 3/10

(57) ABSTRACT

A cup holder structure includes two cup holders and an electronic device holder. The two cup holders are aligned with each other along a longitudinal direction. Each of the two cup holders includes respective cup holder side walls and defines respective cup holder cavities. The electronic device holder extends along the longitudinal direction next to and proximate to both of the two cup holders. The electronic device holder includes an electronic device holder side wall and defines an electronic device holder cavity. The electronic device holder cavity is separated from the cup holder cavities by at least one of the electronic device holder side wall or the cup holder side walls. The electronic device holder may be configured to secure an electronic device in either a portrait orientation or a landscape orientation.

### CROSS-REFERENCE TO RELATED PATENT APPLICATIONS

This application claims priority to and the benefit of U.S. Provisional Patent Application No. 62/658,197, filed Apr. 16, 2018, the entire disclosure of which is incorporated herein by reference.

### FIELD

The present application relates generally to the field of cup holders for use within vehicles. More specifically, the present application relates to a cup holder structure that includes a separate space for storage and/or charging of electronic devices such as cellular phones and the like.

### BACKGROUND

FIG. 1 shows a conventional cup holder structure 130 within a center console 20 of a vehicle that provides two designated areas or cup holders 140 to secure and hold a beverage container 14 (as shown in FIGS. 3-4), such as a cup or a soda can.

When there are no beverage containers 14 within the conventional cup holder structure 130, an electronic device 12 (e.g., a phone) may be stored within the cup holder 140, as shown in FIG. 2. The electronic device 12 may optionally extend at least partially within both of the cup holders 140 along its length or may be positioned upright within only one of the cup holders 140.

When there is one beverage container 14 within the conventional cup holder structure 130 (as shown in FIG. 3), the beverage container 14 is positioned within one of the cup holders 140, and the electronic device 12 is accordingly stored upright within the other cup holder 140.

However, when there are two beverage containers 14 within the conventional cup holder structure 130 (as shown in FIG. 4), one beverage container 14 is positioned within one of the cup holders 140 and the other beverage container 14 is positioned within the other cup holder 140. There is no room within the conventional cup holder structure 130 to store both the electronic device 12 and two beverage containers 14 (in the case where the conventional cup holder structure 130 includes two cup holders 140), and the electronic device 12 is positioned outside of the conventional cup holder structure 130. Accordingly, the conventional cup holder structure 130 cannot hold both the electronic device 12 and the beverage containers 14 when all of the cup holders 140 are full. It would be advantageous to provide a way to provide storage for both beverage containers 14 and electronic devices 12 within one cup holder structure.

### SUMMARY

An exemplary embodiment relates to a cup holder structure that includes two cup holders and an electronic device holder. The two cup holders are aligned with each other along a longitudinal direction. Each of the two cup holders includes respective cup holder side walls and defines respective cup holder cavities. The electronic device holder extends along the longitudinal direction next to and proximate to both of the two cup holders. The electronic device holder includes an electronic device holder side wall and defines an electronic device holder cavity. The electronic device holder cavity is separated from the cup holder cavities by at least one of the electronic device holder side wall or the cup holder side walls.

### BRIEF DESCRIPTION OF THE DRAWINGS

FIG. 1 is a perspective view of a conventional cup holder structure.

FIG. 2 is a perspective view of the conventional cup holder structure of FIG. 1 with an electronic device.

FIG. 3 is a perspective view of the conventional cup holder structure of FIG. 1 with an electronic device and a beverage container.

FIG. 4 is a perspective view of the conventional cup holder structure of FIG. 1 with an electronic device and two beverage containers.

FIG. 5 is a perspective view of a center console with two cup holder structures according to one embodiment.

FIG. 6 is a perspective view of a cup holder structure according to one embodiment.

FIG. 7 is a top view of the cup holder structure of FIG. 6.

FIG. 8 is a cross-sectional view through Section 8-8 of FIG. 7.

FIG. 9 is a cross-sectional view through Section 9-9 of FIG. 7.

FIG. 10 is a perspective view of the cup holder structure of FIG. 6 with an electronic device being placed into the cup holder structure in a vertical, landscape orientation.

FIG. 11 is a perspective view of the cup holder structure of FIG. 6 with an electronic device being placed into the cup holder structure in a vertical, portrait orientation.

FIG. 12 is a top view of a cup holder structure according to another embodiment.

FIG. 13 is a cross-sectional view through Section 13-13 of FIG. 12.

FIG. 14 is a cross-sectional view through Section 14-14 of FIG. 12.

FIG. 15 is a top view of a cup holder structure according to another embodiment.

FIG. 16 is a cross-sectional view through Section 16-16 of FIG. 15.

FIG. 17 is a cross-sectional view through Section 17-17 of FIG. 15.

FIG. 18 is a cross-sectional view of a cup holder structure according to another embodiment.

FIG. 19 is a cross-sectional view of a cup holder structure according to another embodiment.

FIG. 20 is a perspective view of an aligning mechanism according to one embodiment.

FIG. 21 is a perspective view of an aligning mechanism according to another embodiment.

FIG. 22 is a top view of a portion of an interior of a vehicle with a cup holder structure according to one embodiment.

FIG. 23 is a top view of a portion of an interior of a vehicle with a cup holder structure according to another embodiment.

FIG. 24 is a perspective view of a center console with a cup holder structure according to one embodiment.

FIG. 25 is a perspective view of a center console with a cup holder structure according to another embodiment.

FIG. 26 is a perspective view of the center console of FIG. 25 without the cup holder structure.

FIG. 27 is a top view of a cup holder structure according to various embodiments.

FIG. 28 is a cross-sectional view through Section A-A of FIG. 27 according to one embodiment.

FIG. 29 is a cross-sectional view through Section A-A of FIG. 27 according to another embodiment.

FIG. 30 is a cross-sectional view through Section A-A of FIG. 27 according to another embodiment.

FIG. 31 is a perspective view of a cup holder structure according to one embodiment with an electronic device in a landscape orientation.

FIG. 32 is a perspective view of the cup holder structure of FIG. 31 with the electronic device in a portrait orientation.

FIG. 33 is a cross-sectional view through Section 33-33 of FIG. 31.

FIG. 34 is a cross-sectional view through Section 34-34 of FIG. 31.

FIG. 35 is a cross-sectional view through Section 35-35 of FIG. 31.

FIG. 36 is a top view of FIG. 31.

FIG. 37 is a cross-sectional view through Section 37-37 of FIG. 32.

FIG. 38 is a cross-sectional view through Section 38-38 of FIG. 32.

FIG. 39 is a cross-sectional view through Section 39-39 of FIG. 32.

FIG. 40 is a top view of FIG. 32.

FIG. 41 is a cross-sectional view of a cup holder structure according to another embodiment.

FIG. 42 is a side view of FIG. 31.

FIG. 43 is a back view of FIG. 31.

FIG. 44 is a cross-sectional view of a cup holder structure according to another embodiment.

### DETAILED DESCRIPTION

Referring to the figures generally, the various embodiments disclosed herein relate to a cup holder structure that integrates cup holders and electronic device holders together in order to hold and secure both beverage containers and electronic device(s) at the same time.

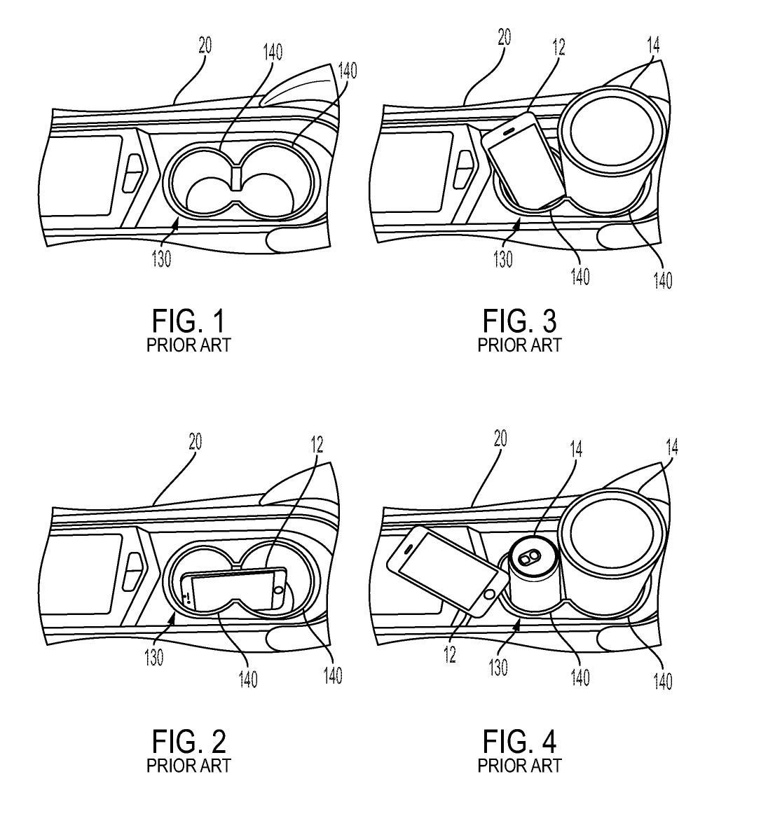

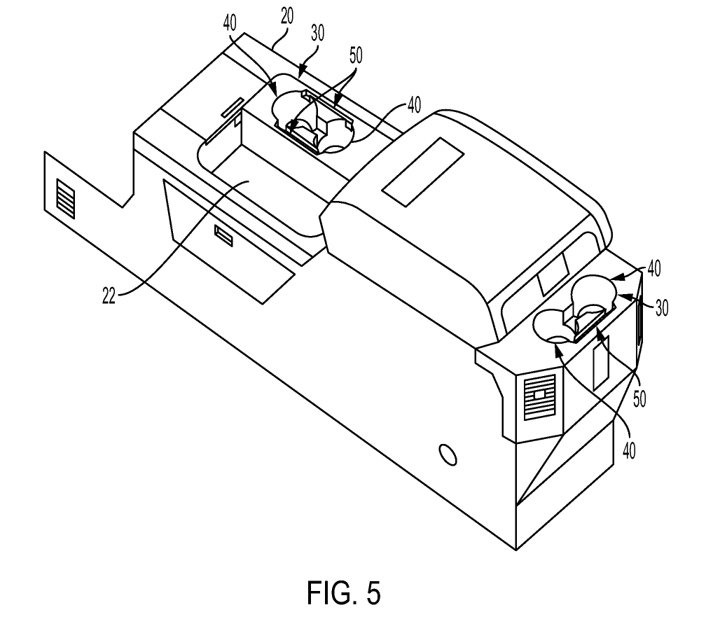

In conventional cup holder structures 130 (as shown in FIGS. 1-4), electronic devices 12 do not have a designated area to be held and secured. Accordingly, if all of the cup holders 140 of the conventional cup holder structure 130 are already holding beverage containers 14 (as shown in FIG. 4), there is no place within the conventional cup holder structure 130 to hold and secure the electronic device 12.

As described further herein, the various cup holder structures described herein can both hold and secure beverage containers in all of the cup holders and hold and secure the electronic device 12 in an electronic device holder. Although the cup holder structure can be used within vehicles of any size, the cup holder structure is particularly beneficial within smaller-sized vehicles that therefore have limited interior storage space or locations (e.g., bins or pockets) for electronic device storage.

FIGS. 5-30 show various embodiments of a cup holder structure 30. As shown in FIG. 5, a cup holder structure 30 is positioned on a center console 20 within a vehicle, although the cup holder structure 30 may be positioned within a variety of different areas within the vehicle depending on where beverage container and electronic device storage is desired. Multiple cup holder structures 30 may be positioned within the center console 20. For example, a cup holder structure 30 may be positioned toward the front of the center console 20 in order to be accessible to passengers in the front seats of the vehicle, and another cup holder structure 30 may be positioned toward the back of the center console 20 in order to be accessible to passengers in the back or rear seats of the vehicle. Furthermore, the cup holder structure 30 may be integrated with a storage area 22 along the center console 20.

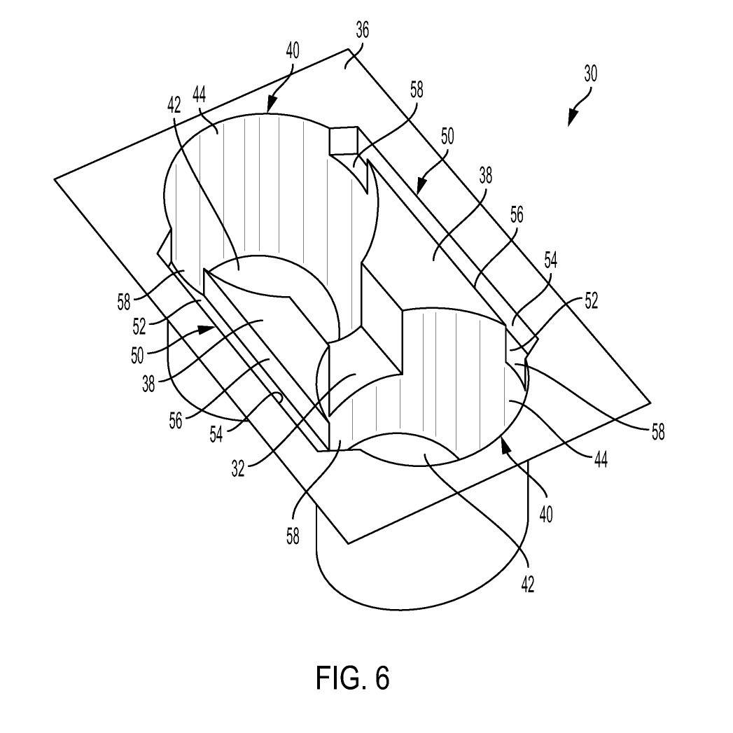

As shown in FIGS. 6-11, the cup holder structure 30 includes at least one cup holder 40 for beverage container storage and at least one electronic device holder 50 for electronic device storage, where the cup holder 40 and the electronic device holder 50 are integrated into one component (as described further herein). The cup holder structure 30 may include two cup holders 40, for example. Due to the electronic device holder 50, even when all of the cup holders 40 within the cup holder structure 30 are full (with, for example, beverage containers), the cup holder structure 30 still provides at least one area (i.e., the electronic device holder 50) to store an electronic device.

The two cup storage containers or holders 40 may be directly next to each other or spaced partially apart by a relatively small recess, opening, or gap 32. The two cup holders 40 are aligned with each other along a longitudinal direction such that a longitudinal horizontal center axis of each of the cup holders 40 are aligned with each other. The gap 32 spaces the cup holders 40 apart horizontally (along the longitudinal direction) and optionally may also extend along at least a portion of the vertical height of the cup holders 40. The cup holder structure 30 may include a top outer wall 36 that extends along the top openings of the cup holders 40 and the electronic device holders 50 and a top inner wall 38 that extends laterally between the electronic device holder 50 and the gap 32 and longitudinally between two cup holders 40. The top inner wall 38 may extend at least partially along the longitudinal length of the electronic device holder 50. According to one embodiment, the top inner wall 38 extends substantially horizontally laterally between the electronic device holder 50 and the gap 32 and the two cup holders 40 and is approximately perpendicular to the second side wall 56 of the electronic device holder 50 and a side wall of the gap 32. According to another embodiment, the top inner wall 38 is angled relative to the second side wall 56 and the side wall of the gap 32 (as described further herein). The top outer wall 36 and the top inner wall 38 may be at approximately the same height according to one embodiment.

The cup holder structure 30 (aside from the wireless charger 70) may be constructed as a single-piece. Accordingly, the cup holder structure 30 comprises a single unitary component that cannot be separated without destruction, and the cup holder 40 and the electronic device holder 50 are integrated together into the layout and design of the same component. Accordingly, the entire cup holder structure (including both the cup holders 40 and the electronic device holders 50) may be formed and styled together.

The cup holders 40 are configured to receive, hold, secure, and store beverage containers (e.g., cups, cans, or bottles that can contain any drinks or liquids (e.g., coffee, tea, water, pop, or soda)). Accordingly, as shown in FIGS. 6-11, each of the cup holders 40 may be hollow with a bottom wall 42 (i.e., define respective cup holder cavities to receive and hold the beverage containers) and include at least one respective side wall 44 (i.e., the cup holder side walls) that extends substantially perpendicularly to the bottom wall 42 and extends around at least a portion of the perimeter of the bottom wall 42. The top of the cup holder 40 is substantially open (i.e., the cup holder 40 does not include a top wall (that would be opposite the bottom wall 42)) in order to provide an area or top opening for the user to insert their beverage container into the cup holder 40. Accordingly, when the beverage container is secured within the cup holder 40, the beverage container rests on the bottom wall 42, the side wall 44 of the cup holder 40 extends along at least a portion of the sides of the beverage container, and the beverage container (if higher than the side walls 44) extends through the top opening of the cup holder 40 (and above the top wall 36 of the cup holder structure 30).

According to one embodiment, the bottom wall 42 may be substantially circular. Accordingly, the side wall 44 extends around at least a portion of the circumference of the bottom wall 42 in a substantially circular manner such that the cup holder 40 is substantially cylindrical. However, it is understood that the cup holder 40 may be a variety of other different hollow shapes.

The vertical height of the cup holders 40 is defined by the vertical distance between the bottom wall 42 of the cup holders 40 and the top wall 36 of the cup holder structure 30, where the bottom wall 42 is lower than and recessed relative to the top wall 36.

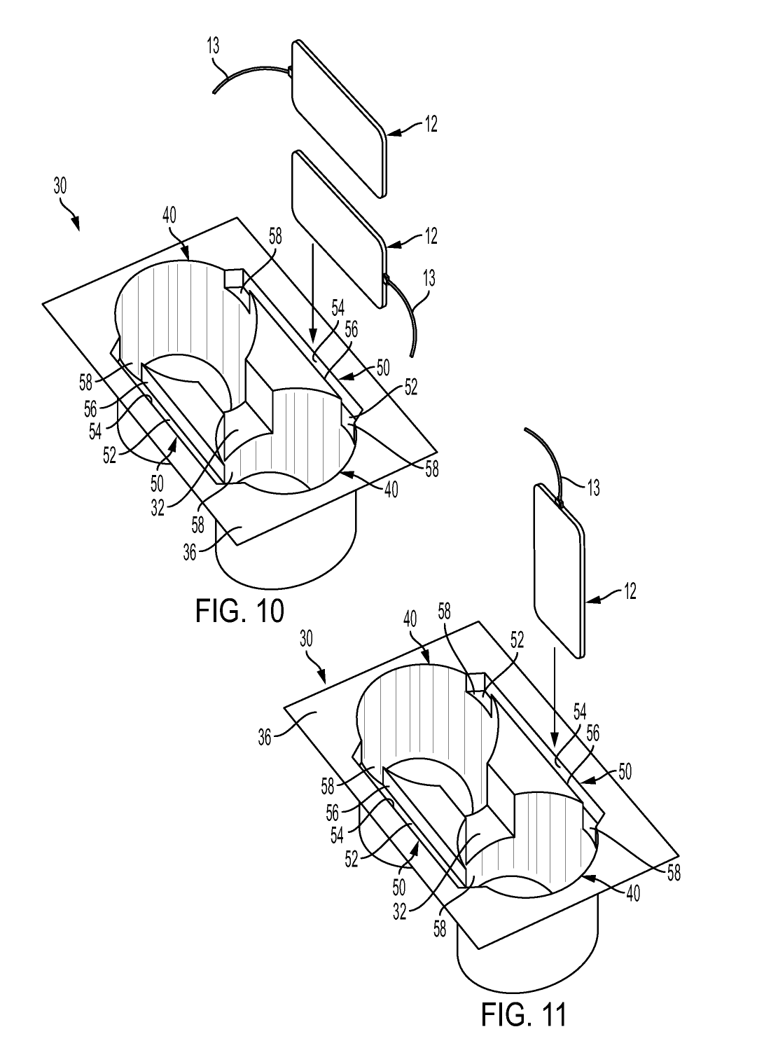

The electronic device storage containers or holders 50 are configured to (and provide a designated location to) receive, hold, secure, and store electronic devices 12 (e.g., a wireless device, a phone, or a tablet and as shown in FIGS. 10-11), even if the cup holders 40 are full of items (e.g., beverage containers). Accordingly, as shown in FIGS. 6-11, the electronic device holder 50 is a hollow, elongated slot defined by and including a bottom wall 52, a first side wall 54, and a second side wall 56 (i.e., the electronic device holder side wall). The electronic device holder 50 defines an electronic device holder cavity to receive and hold the electronic device 12. The first side wall 54 may optionally include end walls of the electronic device holder 50 that also extend substantially perpendicularly to the bottom wall 52 and are positioned at opposite longitudinal ends of the bottom wall 52. The top of the electronic device holder 50 is substantially open (i.e., the electronic device holder 50 does not include a top wall (that would be opposite the bottom wall 52)) in order to provide an area or top opening for the user to insert their electronic device 12 into the electronic device holder 50. Accordingly, when the electronic device 12 is secured within the electronic device holder 50, an edge of the electronic device 12 (that extends between the front and back of the electronic device 12) rests on the bottom wall 52, the first and second side walls 54, 56 of the electronic device holder 50 extend along at least a portion of the front and back faces of the electronic device 12, and the electronic device 12 (if higher than the first and second side walls 54, 56) extends through the top opening of the electronic device holder 50 (and above the top wall 36 of the cup holder structure 30).

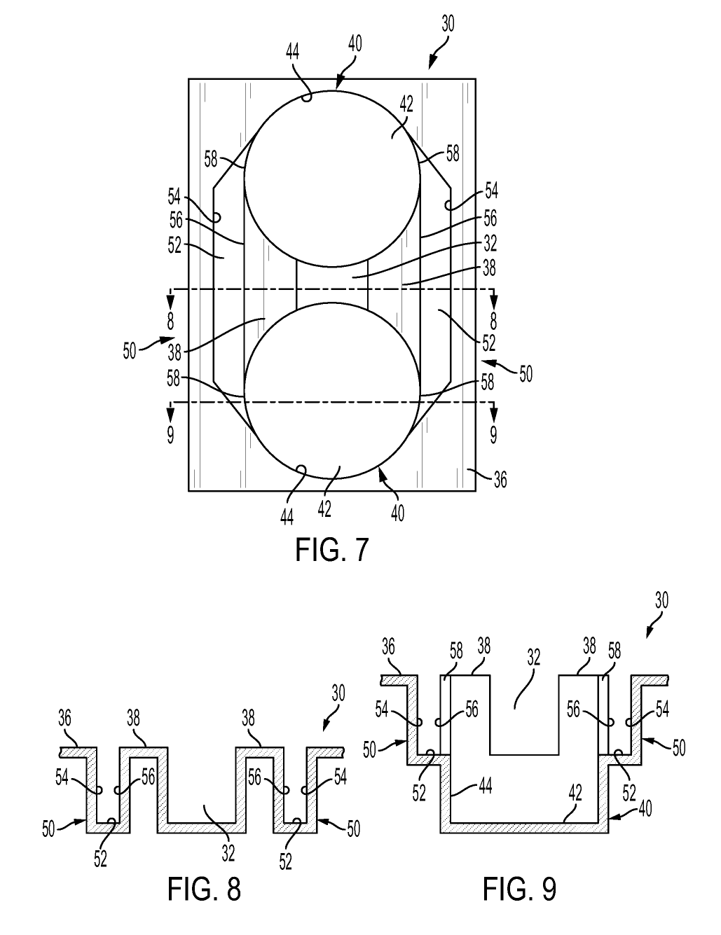

As shown in FIGS. 6-7, each of the electronic device holders 50 are positioned next to (and proximate to) and along opposite sides both of the two cup holders 40. In particular, the electronic device holders 50 extend along each of their longitudinal lengths along the longitudinal direction (that the two cup holders 40 are aligned relative to each other along). Accordingly, the entire depth of the electronic device holder cavity is separated from the entire depth of the cup holder cavities by at least one of the second side wall 56 of the electronic device holder 50 and/or the side walls 44 of the cup holders 40 (i.e., at least one of the second side wall 56 of the electronic device holder 250 and/or the side walls 44 of the cup holders 40 extends and is positioned between the electronic device holder cavity and the cup holder cavities).

Additionally, each of the electronic device holders 50 extends horizontally (longitudinally) and vertically along at least a portion of both of the cup holders 40 and open into each of the cup holders 40 through the respective side walls 44 of the cup holders 40. The bottom walls 42 of the cup holders 40, the bottom walls 52 of the electronic device holders 50, and the top wall 36 of the cup holder structure 30 may be substantially parallel and extend along a horizontal plane. Additionally, the side walls 44 of the cup holders 40 and the first and second sides wall 54, 56 of the electronic device holder 50 may be substantially parallel and extend along a vertical plane.

The vertical height of the electronic device holders 50 is defined by the vertical distance between the bottom wall 52 of the electronic device holders 50 and the top wall 36 of the cup holder structure 30, where the bottom wall 52 is lower than and recessed relative to the top wall 36. However, according to one embodiment, the bottom wall 52 of the electronic device holders 50 may be higher (and closer to the top wall 36) than the bottom wall 42 of the cup holders 40. Accordingly, the vertical height of the electronic device holders 50 may be less than the vertical height of the cup holders 40.

As shown in FIG. 9, the first and second side walls 54, 56 extend substantially perpendicularly to the bottom wall 52 and are positioned along opposite sides of the bottom wall 52. Accordingly, the first side wall 54 is positioned along an outer edge of the bottom wall 52 (i.e., further away from the cup holders 40) and the second side wall 56 is positioned along an inner edge of the bottom wall 52 (i.e., closer toward the cup holders 40).

As shown in FIGS. 10-11, the electronic device 12 may be inserted into and secured and stored within the electronic device holder 50 in a vertical orientation, between the first and second side walls 54, 56. The vertical orientation may either be a landscape orientation (as shown in FIG. 10) or a portrait orientation (as shown in FIG. 11). In both the landscape and portrait orientations, one of the long or short edges of the electronic device 12 is inserted first (i.e., as the leading edge) into the electronic device holder 50 such that, once the electronic device 12 is positioned within the electronic device holder 50, the leading edge of the electronic device 12 is parallel to and directly contacting and being supported by the bottom wall 52 of the electronic device holder 50. Accordingly, the bottom wall 52 extends along a short edge of the electronic device 12 when the electronic device 12 is in the portrait orientation and extends along a long edge of the electronic device when the electronic device 12 is in the landscape orientation. At the same time, the first and second side walls 54, 56 of the electronic device holder 50 are approximately parallel to and are configured to support the front and back faces of the electronic device 12 (i.e., opposite sides of the electronic device 12 that are larger than the long and short edges).

In order to provide an opening 58 leading into each of the cup holders 40 from each of the electronic device holders 50, the horizontal, longitudinal length of the second side wall 56 is less than the respective horizontal, longitudinal lengths of the first side wall 54 and the bottom wall 52. Additionally, the second side wall 56 is centered along the horizontal, longitudinal lengths of the first side wall 54 and the bottom wall 52, which creates two cord pass-through openings 58 along opposite horizontal, longitudinal ends of the second side wall 56. The openings 58 extend laterally between one of the two cup holders 40 and the electronic device holder 50.

These openings 58 provide an area for electronic cords 13 (e.g., charging, USB, and/or AUX cords) that may be plugged into the electronic device 12 to pass into and through the electronic device holder 50 from the cup holders 40 without interference, if needed. This is particularly beneficial when the electronic device 12 is inserted into the electronic device holder 50 in a landscape orientation along its long edge such that the port of the electronic device 12 (to which the cord 13 is attached) is positioned at one of the longitudinal ends of the electronic device holder 50, thus aligning with one of the openings 58 that is also positioned at the longitudinal end of the electronic device holder 50 (as shown in FIG. 10). Since the openings 58 are positioned along both longitudinal ends of the electronic device holder 50, the electronic device 12 can be oriented in the landscape orientation in either direction, resting on either one of its long sides (i.e., with the port of the electronic device 12 and the attached cord 13 extending in either longitudinal direction relative to the longitudinal length of the electronic device holder 50).

The gaps, reliefs, notches, or openings 58 horizontally, laterally lead into the electronic device holder 50 from each of the cup holders 40. Since the electronic device holder 50 is positioned along the vertical height of the cup holders 40, the openings 58 each extend along at least a portion of the respective heights of the side walls 44 of the cup holders 40 and are vertically positioned between a top of a portion of the side walls 44 of the cup holders 40 and the top wall 36 of the cup holder structure 30. Accordingly, the openings 58 are positioned lower than the top wall 36 and the top inner wall 38.

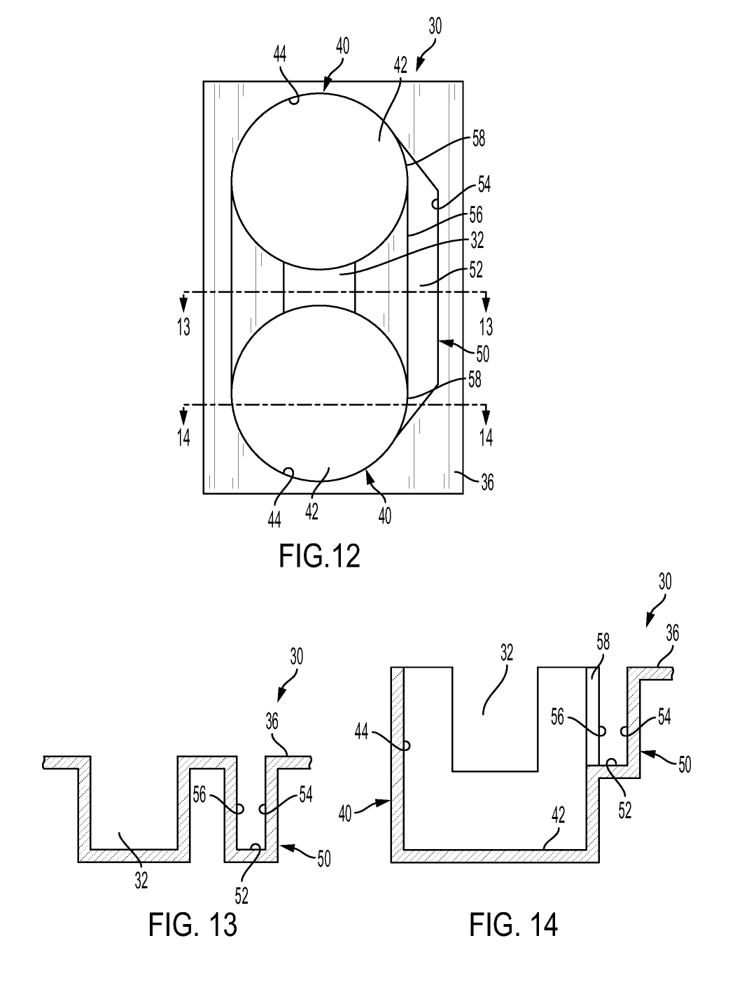

The cup holder structure 30 may include any number of cup holders 40 and electronic device holders 50, according to the desired configuration. For example, the cup holder structure 30 in FIGS. 6-11 has two cup holders 40 that are positioned next to each other and two electronic device holders 50 that are positioned on both sides (i.e., opposite sides) of the two cup holders 40. However, according to another embodiment as shown in FIGS. 12-14, the cup holder structure 30 includes only one electronic device holder 50 (rather than two electronic device holders 50, as shown in FIGS. 6-11). Accordingly, only one side of each of the cup holders 40 is next to an electronic device holder 50.

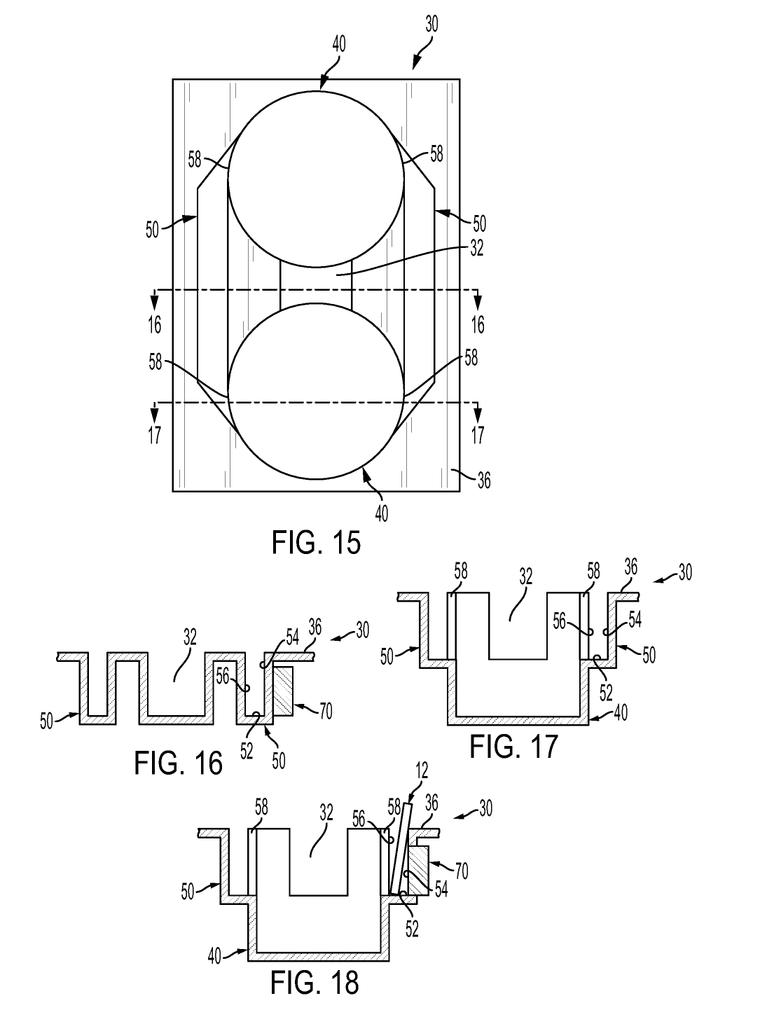

According to one embodiment as shown in FIGS. 15-17, the cup holder structure 30 may further include a wireless charging pad, unit, or mechanism (referred to herein as the wireless charger 70) (and a corresponding wireless charger holder, as described further herein) in order to wirelessly charge the electronic device 12 while the electronic device 12 is positioned within the electronic device holder 50 (as shown in FIG. 18). The wireless charger 70 is vertically oriented or extends vertically along the height of the first side wall 54 in order to align with the electronic device 12, which is also vertically oriented within the electronic device holder 50 (i.e. an edge of the wireless charger 70 (that is between the front and back faces of the electronic device 12) rests on the bottom wall 52 of the electronic device holder 50 such that the electronic device 12 is positioned vertically in either the landscape orientation (as shown in FIG. 10) or the portrait orientation (as shown in FIG. 11)). Accordingly, the wireless charger 70 extends vertically next to and along either the front or back face of the electronic device 12 within the vehicle. The wireless charger 70 and the electronic device 12 are positioned horizontally, laterally next to each other along their sides (rather than placing the electronic device 12 vertically on top of or above the wireless charger 70).

If the cup holder structure 30 includes two (or more) electronic device holders 50, the wireless charger 70 (and a corresponding wireless charger holder) may be positioned along each of electronic device holders 50 such that the electronic device 12 may be charged in any of the electronic device holders 50 (and multiple electronic devices 12 may be charged at the same time in different electronic device holders 50). Alternatively, only one of the electronic device holders 50 may have a wireless charger 70 (as shown in FIG. 16) such that the electronic device 12 will only be wirelessly charged in the one of the electronic device holders 50.

The wireless charger 70 may extend along (or within) at least a portion of the horizontal, longitudinal length of the first side wall 54 and vertically below the top wall 36 of the cup holder structure 30 in order to be obscured within the cup holder structure 30 and while still being positioned near the electronic device 12 when within the electronic device holder 50. As shown in FIGS. 16-17, the wireless charger 70 may only extend along a portion of the electronic device holder 50 that aligns with the center gap 32 of the cup holder structure 30. According to another embodiment as shown in FIG. 18, the wireless charger 70 may extend along a portion of the electronic device holder 50 that aligns with one or both of the cup holders 40 (and optionally also the center gap 32).

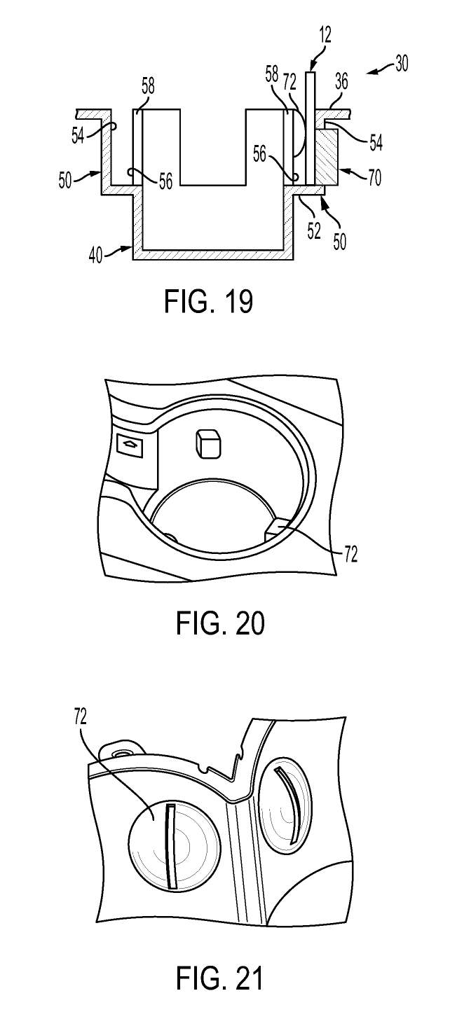

According to another embodiment, in order to achieve the optimal charging rate for the electronic device 12, the second side wall 56 may include an aligning mechanism 72 (as shown in FIGS. 19-21) in order to align and bias the electronic device 12 to the wireless charger 70 (and thus also to the wireless charger holder) and/or to the first side wall 54. Specifically, the aligning mechanism 72 positions the electronic device 12 within the electronic device holder 50 such that the respective outer surfaces of the electronic device 12 and the wireless charger 70 (or the inner surface of the first side wall 54) are flush with each other (as shown in FIG. 19).

The aligning feature, form, shape, or mechanism 72 is positioned directly opposite the wireless charger 70 across the width of the electronic device holder 50 such that the electronic device 12 is sandwiched and secured upright between the aligning mechanism 72 and the wireless charger 70. When the aligning mechanism 72 aligns the electronic device 12 to create flush contact between the electronic device 12 and the wireless charger 70, the electronic device 12 and the wireless charger 70 are substantially parallel, as shown in FIG. 19.

According to one embodiment, the aligning mechanism 72 may be a knob, protrusion, bump, movable plastic “fingers” (as shown in FIG. 20), or a rubber “football” shape (as shown in FIG. 21) that extends outward from the inner surface of the second side wall 56 and is flexible in order to adapt to and secure electronic devices 12 (and their respective case) of a variety of different sizes (in particular thicknesses). According to another embodiment, the aligning mechanism 72 may be a rubber mat or strap. The aligning mechanism 72 may also be used without the wireless charger 70 to further secure the electronic device 12 within the electronic device holder 50.

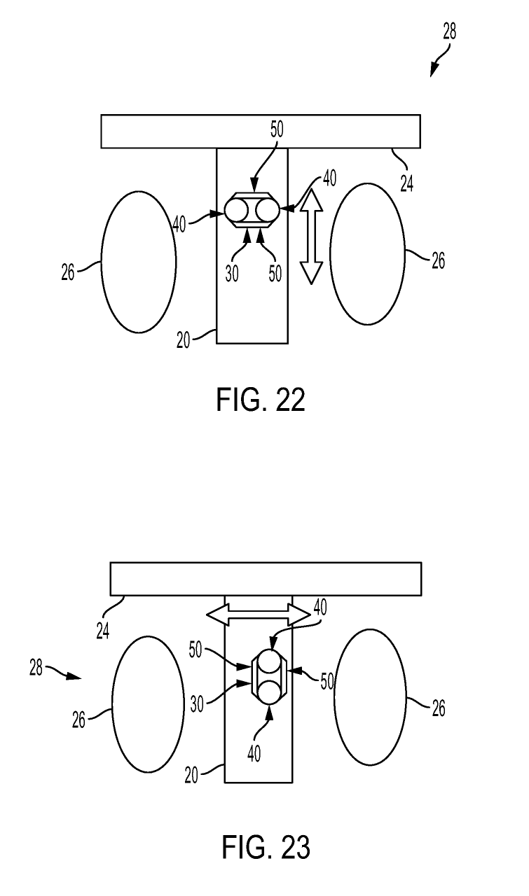

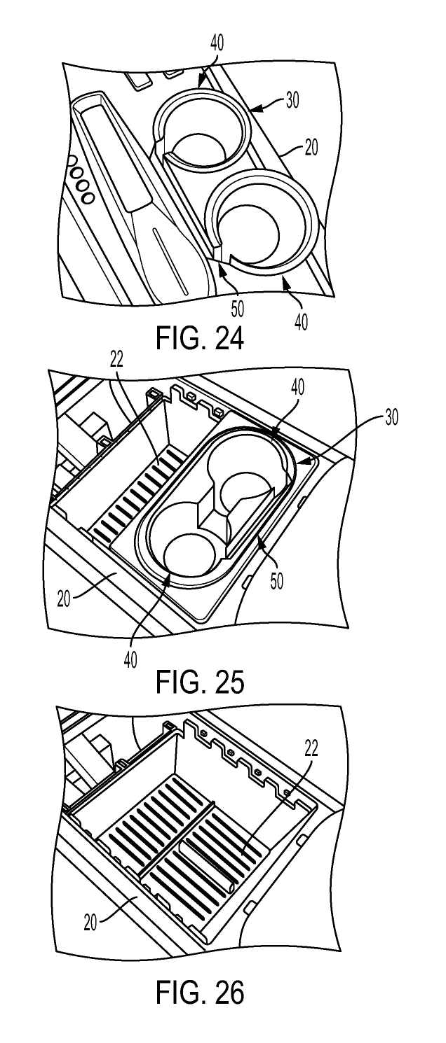

As shown in FIGS. 22-23, the entire cup holder structure 30 may be oriented in any direction within a vehicle 28. For example, the electronic device holder 50 (and the entire cup holder structure 30) may be substantially parallel to (see FIG. 22) or substantially perpendicular to (see FIG. 23) the instrument panel 24 that extends along a front interior area of the vehicle 28. Accordingly, depending on the number of electronic device holders 50 that the cup holder structure 30 includes and the overall orientation of the cup holder structure 30 within the vehicle 28, the cup holder structure 30 may include only one electronic device holder 50 closer to the instrument panel 24 (i.e., toward the front of the vehicle 28) than the cup holders 40, only one electronic device holder 50 further from the instrument panel 24 (i.e., toward the back of the vehicle 28) than the cup holders 40, two electronic device holders 50 positioned closer to the front of the vehicle 28 and closer to the back of the vehicle 28, respectively, relative to the cup holders 40 (as shown in FIG. 22), only one electronic device holder 50 closer to the seat 26 on the driver side than the cup holders 40, only one electronic device holder 50 closer to the seat 26 on the passenger side than the cup holders 40, or two electronic device holders 50 positioned closer to the seat 26 on the driver side and closer to the seat 26 on the passenger side, respectively, relative to the cup holders 40 (as shown in FIG. 23).

Furthermore, as shown in FIG. 22, the entire cup holder structure 30 may be positioned closer to or further from the instrument panel 24 (i.e., the front of the vehicle 28) along the lengthwise direction of the vehicle 28 (and along the center console 20) in order to be more accessible to the front of the vehicle 28 or to the back of the vehicle 28. Additionally, as shown in FIG. 23, the entire cup holder structure 30 may be positioned closer to either the driver side or the passenger side of the vehicle 28 (i.e., closer to one of the seats 26 than the other seat 26) along the width of the vehicle 28 (and along the center console 20). Although the cup holder structure 30 is shown in a center console 20 positioned between two seats 26 for passengers, the cup holder structure 30 may be integrated into other areas of the vehicle 28.

As shown in FIGS. 24-26, the cup holder structure 30 may have a variety of different structures and features, depending on the desired configuration. For example, according to one embodiment as shown in FIG. 24, the entire cup holder structure 30 may be static, fixed, and not movable within the vehicle or relative to the center console 20.

According to another embodiment as shown in FIGS. 25-26, the entire cup holder structure 30 may be attachable to the center console 20 (as shown in FIG. 25) and removable from the vehicle (and specifically from the center console 20) (as shown in FIG. 26). Additionally, the entire cup holder structure 30 may optionally be moved (and subsequently fixed) to different areas of or positions along the center console 20 (or within the vehicle). Accordingly, a storage area 22 may be positioned at least partially beneath the cup holder structure 30 (and optionally within the center console 20). The storage area 22 can be at least partially accessed when the cup holder structure 30 is removed from or moved along the center console 20.

According to another embodiment, the entire cup holder structure 30 may be movable relative to the body of the center console 20 between a first position and a second position. For example, the cup holder structure 30 may move or slide in and out between the closed or first position in which the cup holder structure 30 is positioned at least partially within the inner area in the center console 20 and the home, open, or second position in which the cup holder structure 30 is positioned at least partially outside of an inner area in the center console 20. The cup holder structure 30 is at least partially obscured or not visible in the first position in order to provide a clean and sleek design when not in use. In order to be at least partially revealed, accessible, and usable, the cup holder structure 30 can be moved or slide out from within the center console 20 into the second position (or in a partially-open position).

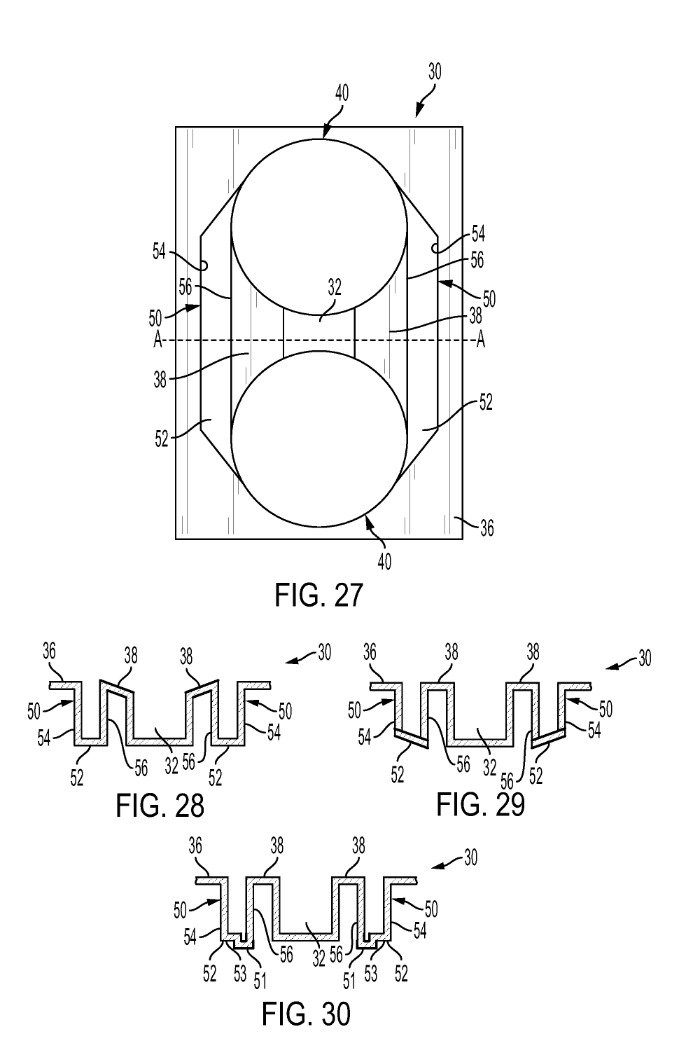

According to various embodiments as shown in FIGS. 27-30, the cup holder structure 30 may include various features (e.g., anti-drip edges or surfaces) within or near the electronic device holder 50 to prevent the electronic device 12 from getting wet. This liquid may be from, for example, liquid that spills out from the cups within the cup holders 40 or due to liquid sweating from the outside of the cups. The various “anti-drip” features described herein may be used in conjunction with each other or separately, depending on the desired configuration.

According to one embodiment as shown in FIG. 28, the top inner wall 38 extends downwardly at an oblique angle from the second side wall 56 of the electronic device holder 50 to the corresponding side wall of the gap 32 and/or the side walls 44 of the cup holders 40 (relative to the second side wall 56 of the electronic device holder 50, a side wall of the gap 32, and the side walls 44 of the cup holders 40). This configuration directs and drains liquid away from the electronic device holder 50 and toward the gap 32 and the cup holders, thereby reducing the likelihood that liquid will enter or drip into the electronic device holder 50.

According to another embodiment as shown in FIG. 29, the bottom wall 52 of the electronic device holder 50 extends at an oblique angle between an upper portion along the first side wall 54 and a lower portion along the second side wall 56 in order to direct and drain any liquid within the electronic device holder 50 toward one side of the electronic device holder 50. In particular, the bottom wall 52 is angled such that the bottom wall 52 extends downward from the first side wall 54 to the second side wall 56, thereby directing any liquid to flow away from the upper side at the first side wall 54 and toward the lower side at the second side wall 56. The angle of the bottom wall 52 is relatively small in order to still allow the electronic device 12 to be properly aligned with the wireless charger 70 for wireless charging, while still directing liquid to the lower portion of the bottom wall 52.

According to another embodiment as shown in FIG. 30, the bottom wall 52 includes a lower portion 51 (e.g., a notch, divot, well, or recess) and an upper portion 53 that are configured such that any liquid within the electronic device holder 50 is directed and drained toward the lower portion 51. The upper portion 53 is vertically higher than the lower portion 51 such that any liquid within the electronic device holder 50 flows toward and into the lower portion 51, which is the lowest portion of the electronic device holder 50. The width of the lower portion 51 may be small enough such that the electronic device 12 cannot fit within the lower portion 51. For example, according to one embodiment, the lower portion 51 may be approximately 2 millimeters (mm) wide and 2 mm deep (relative to the upper portion 53).

The lower portion 51 and the upper portion 53 extend along at least a portion of the longitudinal length of the electronic device holder 50 (i.e., along or next to the two cup holders 40) and are positioned next to each other along the lateral width of the electronic device holder 50 (i.e., between the first side wall 54 and the second side wall 56). The upper portion 53 may extend from and be positioned along the first side wall 54, and the lower portion 51 may extend from and be positioned along the second side wall 56 (where the upper portion 53 and the lower portion 51 connect together along the lateral width of the electronic device holder 50).

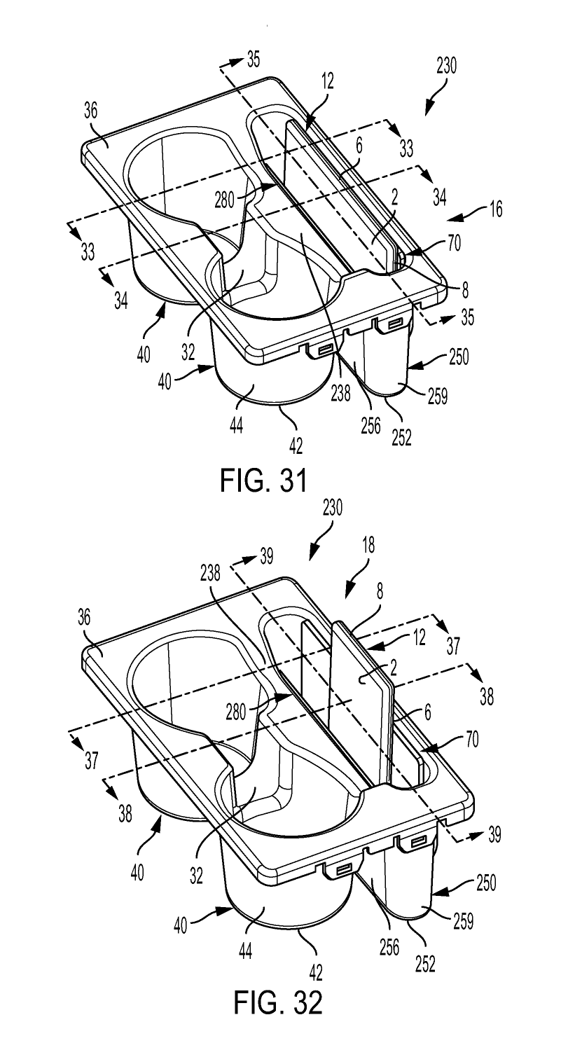

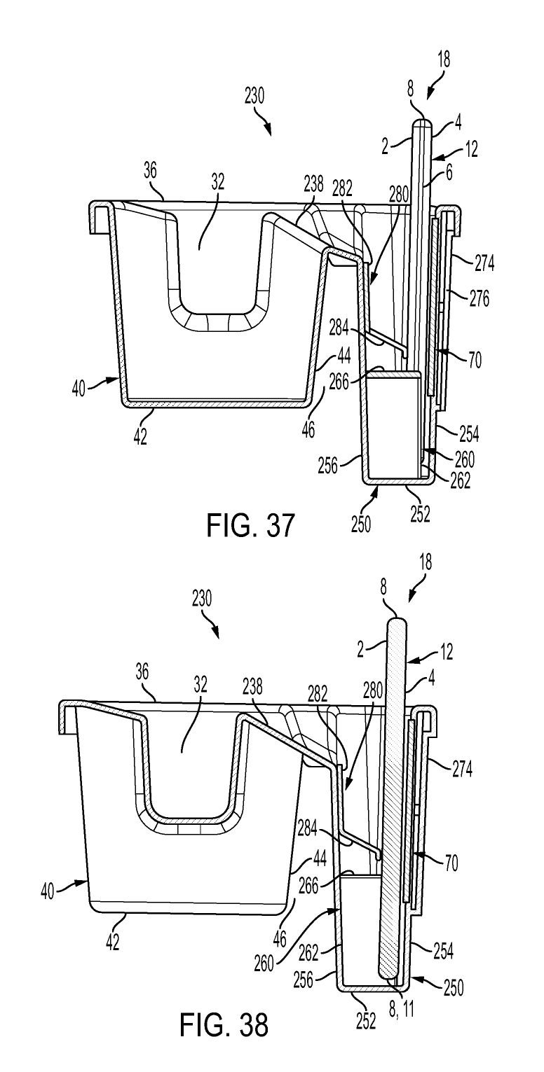

FIGS. 31-44 show another embodiment of a cup holder structure 230. The cup holder structure 230 can include all of the various features, components, and configurations of the cup holder structure 30 (and vice versa), unless otherwise noted in the description herein, depending on the desired configuration. For example, the cup holder structure 230 can also be positioned in a variety of different areas within a vehicle, including the center console 20 (as shown and described further herein).

As show in FIGS. 31-32, the cup holder structure 230 also includes at least one cup holder 40 (for example, two cup holders 40, as described in more detail herein) and at least one electronic device holder 250 for storage of the electronic device 12 (as described further herein). Accordingly, even when all of the cup holders 40 within the cup holder structure 230 are occupied (with, for example, beverage containers), the cup holder structure 230 still provides at least one area (i.e., the electronic device holder 250) to store an electronic device. Unless otherwise noted in the description herein, the electronic device holder 250 may include all of the various features, components, and configurations of the electronic device holder 50, depending on the desired configuration.

As shown in various figures, the electronic device 12 includes different sides. In particular, the electronic device 12 includes a front face 2, a back face 4, two long edges 6, and two short edges 8. The front and back faces 2,4, are opposite each other and surrounded by the long edges 6 and the short edges 8. The long edges 6 are opposite each other, and the short edges 8 are opposite each other. The front face 2 of the electronic device 12 may be, for example, the primary screen of the electronic device 12. The long edges 6 and the short edges 8 each extend between the front face 2 and the back face 4. The long edges 6 and the short edges 8 of the electronic device 12 are substantially smaller in surface area than the front and back faces 2, 4. The long edges 6 are longer than the short edges 8, although the long edges 6 and the short edges 8 may have the same width.

The cup holder structure 230 may also include two cup holders 40 positioned directly next to each other or spaced partially apart by a relatively small gap 32 (as described further herein). As described further herein, the cup holders 40 each include the bottom wall 42 and the at least one side wall 44 (as described further herein). The cup holder structure 230 may include the top outer wall 36 (as described further herein) and an inner angled top wall 238 that extend along the top portions and openings of the cup holders 40 and the electronic device holder 250. The angled top wall 238 may be similar to and include the various features and components of the top inner wall 38, unless otherwise noted in the description herein

The cup holder structure 230 (aside from the wireless charger 70 and the aligning mechanism 280) may be constructed as a single-piece. Accordingly, the cup holder structure 230 comprises a single unitary component that cannot be separated without destruction, and the cup holder 40 and the electronic device holder 250 are integrated together into the layout and design of the same component. Accordingly, the entire cup holder structure 230 (including both the cup holders 40 and the electronic device holder 250, but excluding the wireless charger 70 and the aligning mechanism 280) may be formed and styled together.

The electronic device holder 250 is configured to (and provides a designated location to) receive, hold, secure, and store an electronic device 12 (e.g., a wireless device, a phone, or a tablet (as shown in FIGS. 31-44), as described further herein), even if the cup holders 40 are full of items (e.g., beverage containers). As described further herein, the electronic device holder 250 is configured to secure the electronic device 12 in multiple different vertical orientations (i.e., in a landscape orientation 16 or a portrait orientation 18) while providing wireless charging to the electronic device 12.

In order to store the electronic device 12, as shown in FIGS. 31-32 (as well as FIGS. 36 and 40), the electronic device holder 250 is an elongated slot defined by and including a substantially horizontal bottom wall 252, a first substantially vertical side wall 254, and a second substantially vertical side wall 256 (i.e., the electronic device holder side wall) (each of which may be similar to and include the various features and components of the bottom wall 52, the first side wall 254, and the second side wall 256, respectively, unless otherwise noted in the description herein). The electronic device holder 250 defines an electronic device holder cavity to receive and hold the electronic device 12. The first side wall 254 is positioned along an outer edge of the bottom wall 252 (i.e., further away from the cup holders 40 than the second side wall 256), and the second side wall 256 is positioned along an inner edge of the bottom wall 252 (i.e., closer to the cup holders 40 than the first side wall 254). The first and second side walls 254, 256 extend longitudinally along the length of the bottom wall 252 and are positioned along opposite lateral sides of the bottom wall 252. The electronic device holder 50 also includes two substantially vertical end walls 259 that extend laterally between (and are substantially perpendicular to) the first side wall 254 and the second side wall 256 and are positioned at opposite longitudinal ends of the bottom wall 252.

The first side wall 254, the second side wall 256, and the end walls 259 are substantially perpendicular to the bottom wall 252 and define the total vertical height of the electronic device holder 250. Additionally, the first side wall 254 and the second side wall 256 are substantially parallel to each other, the end walls 259 are substantially parallel to each other, and the bottom wall 252 and the top wall 36 are substantially parallel to each other. Accordingly, when the electronic device 12 is secured within the electronic device holder 250, at least a portion of each of the front face 2 and the back face 4 of the electronic device 12 extends along (and is substantially parallel to) a portion of the first and second side walls 254, 256 of the electronic device holder 250, respectively, either the long edges 6 or the short edges 8 (depending on the orientation of the electronic device 12) are substantially parallel to and extend along the end walls 259, and the other of the long edges 6 and the short edges 8 of the electronic device 12 are substantially parallel to the bottom wall 252.

The top of the electronic device holder 250 is substantially open (i.e., the electronic device holder 250 does not include a top wall (that would be opposite the bottom wall 252)) in order to provide an area or top opening for the user to insert their electronic device 12 into the electronic device holder 250. Depending on the size and orientation of the electronic device 12 (as described further herein), the electronic device 12 may extend through the top opening of the electronic device holder 250 (and above the top wall 36 of the cup holder structure 230).

As shown in FIGS. 31-32, the electronic device holder 250 is positioned along the lateral sides of two cup holders 40 and extends horizontally (longitudinally) and vertically along at least a portion of both of the cup holders 40 (although the electronic device holder 250 may be positioned along the side of any number of cup holders 40 and/or two electronic device holders 250 may be positioned along opposite sides of the cup holder(s) 40). As described further herein regarding the electronic device holder 50, the cup holder structure 30 may include any number of cup holders 40 and electronic device holders 250, according to the desired configuration. The bottom walls 42 of the cup holders 40, the bottom wall 252 of the electronic device holder 250, and the top wall 36 of the cup holder structure 30 may be substantially parallel to each other and extend along a horizontal plane. Additionally, at least a portion of the side walls 44 of the cup holders 40 and the first and second sides wall 254, 256 of the electronic device holder 250 may be substantially parallel and extend along a vertical plane.

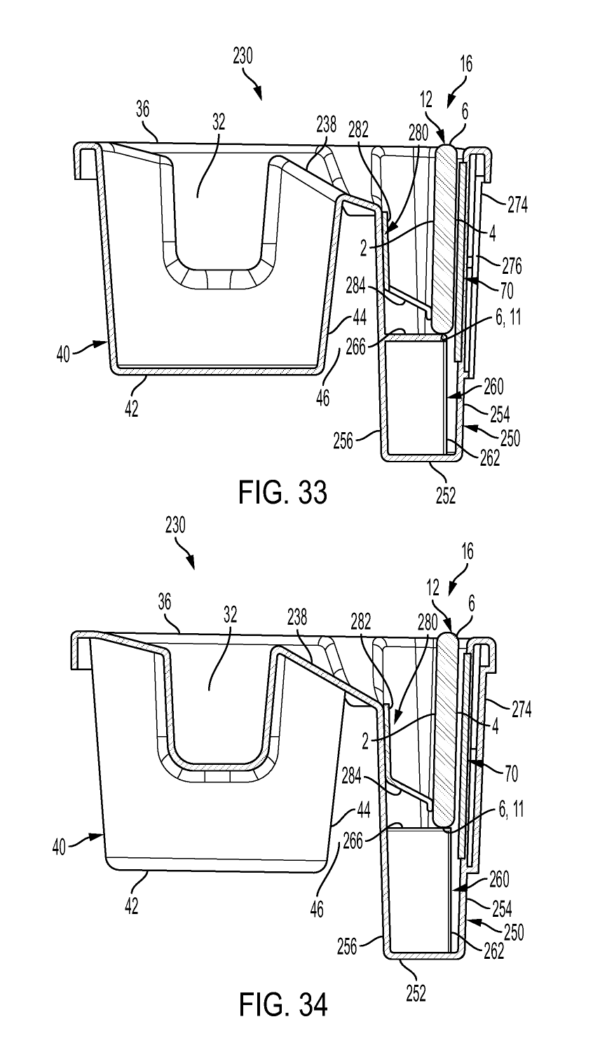

As shown in FIGS. 31-34, the electronic device holder 250 is positioned directly or indirectly next to or proximal to the cup holders 40. The electronic device holder 250 and the cup holders 40 are close enough to each other that they can be molded as a single piece of material (as described further herein). The entire depth of electronic device holder cavity is separated from the entire depth of the cup holder cavities by at least one of the second side wall 256 of the electronic device holder 250 and/or the side walls 44 of the cup holders 40 (i.e., at least one of the second side wall 256 of the electronic device holder 250 and/or the side walls 44 of the cup holders 40 extends and is positioned between the electronic device holder cavity and the cup holder cavities). According to one embodiment, the electronic device holder 250 and the cup holders 40 may share an approximately vertical wall (i.e., the second side wall 256 and the side walls 44 may be the same wall). Alternatively, the electronic device holder 250 and the cup holders 40 may be spaced slightly apart from each other. Accordingly, the second side wall 256 of the electronic device holder 250 and the side wall 44 of the cup holders 40 (that is closest to the electronic device holder 250) may be separated from each other by a recess, opening, or gap 46, as shown in FIGS. 33-34. The electronic device holder 250 includes an inner angled top wall 238 extends continuously at an oblique angle between a top portion of a side wall 44 of the two cup holders 40 and a top portion of the second side wall 256 of the electronic device holder 250.

The angled top wall 238 allows the electronic device 12 to be easily inserted into the electronic device holder 250 for storage (as well as easily removed from the electronic device holder 250). In particular, as shown in FIGS. 33-34, the angled top wall 238 extends downwardly at an oblique angle from a top of a side wall of the two cup holders 40 (and a side wall of the gap 32) to a top of the second side wall 256 of the electronic device holder 250 such that the angled top wall 238 does not extend substantially along a horizontal plane. Accordingly, the top inner edge of the electronic device holder 250 (i.e., the edge that is closer to the cup holders 40) is vertically lower than the top inner edge of the cup holders 40 (i.e., the edge that is closer to the electronic device holder 250). This configuration increases the overall size (in particular the width) of the top opening leading into the electronic device holder 250, which allows the user to more easily locate the electronic device 12 to the electronic device holder 250 and insert the electronic device 12 into the electronic device holder 250 (or to remove the electronic device 12 from the electronic device holder 250). For example, the electronic device 12 does not need to be inserted into (or removed from) the electronic device holder 250 in an exactly vertical orientation, but instead can be inserted into the electronic device holder 250 at an angle, which is then corrected by the rest of the electronic device holder 250 (e.g., by the aligning mechanism 280, as described further herein) as the electronic device 12 is moved further into the electronic device holder 250. The slope of the angled top wall 238 helps direct the electronic device 12 to be moved into the electronic device holder 250 (rather than another area, such as the cup holders 40). Additionally, by increasing the size of the opening of the electronic device holder 250, the electronic device 12 can be more easily connected to a wire (for wired charging, for example) while positioned within the electronic device holder 250.

As shown in FIGS. 31-40, the electronic device 12 may be inserted into and secured and stored within the electronic device holder 250 in a vertical orientation, between the first and second side walls 254, 256. The vertical orientation may be either a landscape orientation 16 (as shown in FIGS. 31 and 33-36) or a portrait orientation 18 (as shown in FIGS. 32 and 37-40), depending on the user's desired orientation of the electronic device 12.

In order to be vertically oriented within the electronic device holder 250, one long edge 6 or one short edge 8 of the electronic device 12 is inserted first (i.e., as the leading edge 1) into the electronic device holder 250 such that, once the electronic device 12 is positioned within the electronic device holder 250, the leading edge 11 of the electronic device 12 is parallel to the bottom wall 252 of the electronic device holder 50. At the same time, the first and second side walls 254, 256 of the electronic device holder 250 are approximately parallel to the front face 2 and the back face 4 of the electronic device 12. In the vertical orientation, the front face 2 and the back face 4 of the electronic device 12 extend vertically within the electronic device holder 250 (rather than a horizontal orientation in which the electronic device 12 would have a laid flat on one of the front face 2 or the back face 4 and the front face 2 and the back face 4 would have been substantially parallel to a horizontal plane).

In order to support and secure the electronic device 12 in both the landscape orientation 16 and the portrait orientation 18 (depending on the user's preference), the electronic device holder 250 includes an electronic device edge stabilizer 260 that stabilizes the electronic device 12 within the electronic device holder 250 by extending along either one or both of the long edges 6 of the electronic device 12 (depending on the orientation of the electronic device 12), as shown in FIGS. 33-40. At the same time, the first side wall 254 and the aligning mechanism 280 (as described further herein) are configured to support the front and back faces 2, 4 of the electronic device 12. The edge stabilizer 260 and the aligning mechanism 280 together ensure that the electronic device 12 is both secured within the electronic device holder 250 and always aligned with the wireless charger 70.

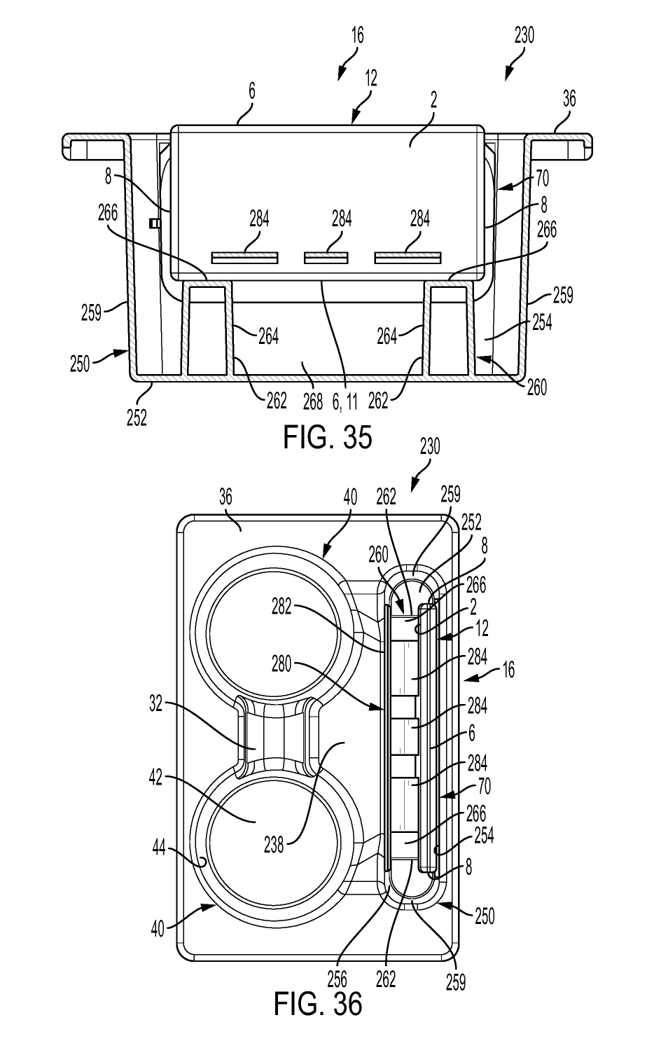

As shown in FIG. 35, the edge stabilizer 260 includes at least one (preferably two) extension, riser, uplift part, step, strut, rib, shelf, ledge, or protrusion 262 that has an inner side surface 264 and a top surface 266. Each of the protrusions 262 are positioned within the electronic device holder 250 such that the top surfaces 266 are positioned vertically between and parallel to the top wall 36 and the bottom wall 252. The top surfaces 266 are positioned above the bottom wall 252 by a vertical distance (which may be the vertical height of the inner side surfaces 264).

The respective inner side surfaces 264 face each other, and the protrusions 262 are spaced apart from each other in the horizontal, longitudinal direction by a gap 268 that is between the inner side surfaces 264 and is configured to receive at least a portion of the electronic device 12 (i.e., one of the short edges 8) in the portrait orientation 18. The gap 268 is large enough in order to fit the entire length of one of the short edges 8 of the electronic device 12 between the protrusions 262 (in the portrait orientation 18) and small enough to be smaller than the long edge 6 of the electronic device 12. Accordingly, the protrusion 262 may optionally extend vertically upwardly from the bottom wall 252 and laterally outwardly from the first side wall 254 and/or the second side wall 256. The protrusion 262 are, however, aligned with each other along the horizontal, lateral direction (i.e., the width of the electronic device holder 250) (as best seen in FIG. 40), and the top surfaces 266 of each of the protrusions 262 are vertically aligned with each other (as shown in FIG. 35).

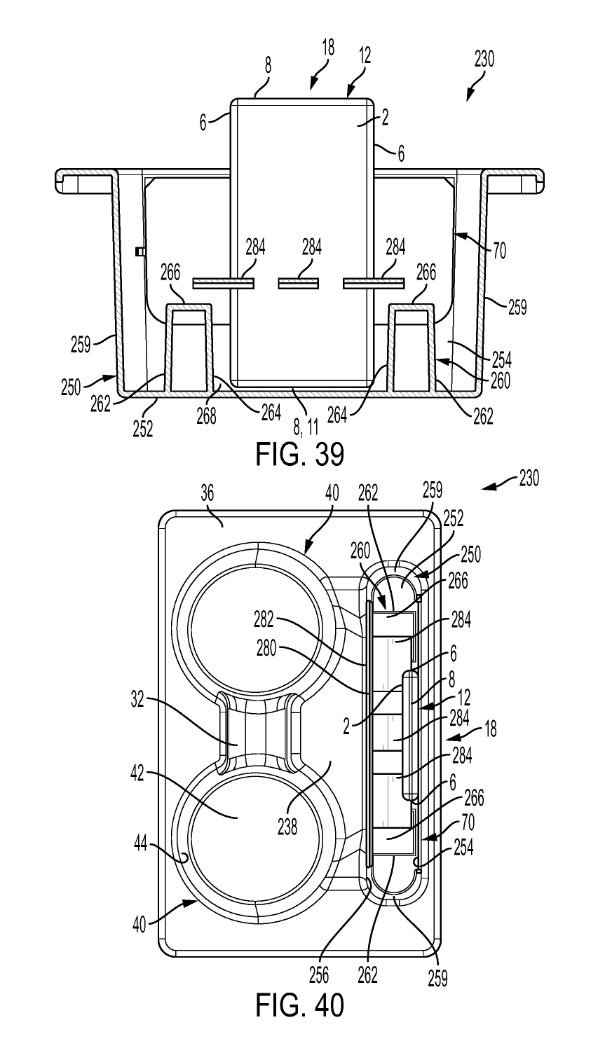

As shown in FIG. 35, when the electronic device 12 is in the landscape orientation 16, the two protrusions 262 elevate the electronic device 12 above the bottom wall 252, which prevents the electronic device 12 from falling too far down into the electronic device holder 250. As shown in FIG. 39, when the electronic device 12 is in the portrait orientation 18, the two protrusions 262 prevent the electronic device 12 from falling over or moving longitudinally and keep the electronic device 12 in the upright, vertical position. Accordingly, in both the landscape orientation 16 and the portrait orientation 18, the protrusions 262 help secure the electronic device 12 and align the electronic device 12 to the wireless charger 70.

In the landscape orientation 16 (as shown in FIGS. 31 and 33-36), the electronic device 12 is oriented such that the electronic device 12 is wider than it is tall, and one of the long edges 6 is the leading edge 11 of the electronic device 12 (i.e., the lowermost edge that is inserted into the electronic device holder 250 first). Accordingly, once the electronic device 12 is inserted into the electronic device holder 250 in the landscape orientation 16, the long edge 6 (that is the leading edge 11) of the electronic device 12 is positioned on the top surfaces 266 of both of the protrusion 262 such that the top surfaces 266 of both of the protrusions 262 each extend along (and directly support and contact) at least a portion of this long edge 6, as shown in FIGS. 33-35. The electronic device 12 is elevated vertically above both the bottom wall 252 (by the vertical distance that the top surfaces 266 are elevated above the bottom wall 252) and the protrusions 262. In particular, the protrusions 262 elevate the long edge 6 (that is the leading edge 11) of the electronic device 12 above the bottom wall 252 by the vertical distance within the electronic device holder 250, thereby aligning the electronic device 12 to the wireless charger 70. The bottom wall 252 of the electronic device holder 250 and the top surfaces 266 of the protrusions 262 extend parallel to the long edges 6 of the electronic device 12 and perpendicular to the short edges 8. In the landscape orientation 16, the electronic device 12 spans across at least a portion of both protrusions 262 and across the gap 268.

In the portrait orientation 18 (as shown in FIGS. 32 and 37-40), the electronic device 12 is oriented such that the electronic device 12 is taller than it is wide, and one of the short edges 8 is the leading edge 11 of the electronic device 12. Accordingly, once the electronic device 12 is inserted into the electronic device holder 250 in the portrait orientation 18, the short edge 8 (that is the leading edge 11) of the electronic device 12 is positioned on the bottom wall 252 within the gap 268, between the two protrusions 262 such that the bottom wall 252 extends along (and directly supports and contacts) the entire short edge 8, as shown in FIGS. 38-39. A lower portion of the electronic device 12 is positioned horizontally (longitudinally) in between the inner side surfaces 264 of the two protrusions 262, within the gap 268. Furthermore, each of the inner side surfaces 264 extend along and can directly support a portion of each of the long edges 6 of the electronic device 12 (as shown in FIGS. 39-40), thereby longitudinally aligning the electronic device 12 with the wireless charger 70. The bottom wall 252 of the electronic device holder 250 extends parallel to the short edges 8 of the electronic device 12 and perpendicular to the long edges 6.

The electronic device holder 250 further the wireless charger 70 (and a corresponding wireless charger holder 274, both of which are described further herein) that allows the electronic device 12 to be wirelessly charged while being stored or positioned within the electronic device holder 250. As shown in FIGS. 32-34, the wireless charger 70 is positioned along and extends along the first side wall 54 of the electronic device holder 250. The wireless charger 70 extends substantially along both the height and length of the electronic device holder 250 in order to allow the electronic device 12 to be wirelessly charged in both vertical orientations (i.e., both the landscape orientation 16 and the portrait orientation 18). Since the electronic device 12 is oriented vertically in either the landscape orientation 16 and the portrait orientation 18, the wireless charger 70 extends vertically next to and along either the front face 2 or the back face 4 of the electronic device 12 (depending on the orientation of the electronic device 12). Accordingly, the wireless charger 70 and the electronic device 12 are positioned horizontally, laterally next to each other along their sides (rather than placing the electronic device 12 in a horizontal orientation, vertically on top of or above the wireless charger 70).

The wireless charger 70 may extend along (or within) at least a portion of the horizontal, longitudinal length of the first side wall 254 and vertically below the top wall 36 of the cup holder structure 230 in order to be obscured within the cup holder structure 230 and while still being positioned near the electronic device 12 when within the electronic device holder 250. As shown in FIGS. 35 and 39, the wireless charger 70 extends at least partially vertically above the respective top surfaces 266 of the protrusions 262 and horizontally, longitudinally between the two protrusions 262 in order to align with at least the middle portion of the electronic device 12 in both the landscape orientation 16 and the portrait orientation 18. Both the edge stabilizer 260 and the aligning mechanism 280 (both of which are described further herein) ensure that the electronic device 12 is properly positioned relative to the wireless charger 70 in order to properly charge the electronic device 12. The wireless charger 70 may include a protective case, mat, or cover that covers at least a portion of the charging mechanism of the wireless charger 70 for protection.

In order to achieve the optimal charging rate for the electronic device 12, the electronic device holder 250 includes a face stabilizer, biasing mechanism, or aligning mechanism 280 (as shown in FIGS. 33-36) that is configured to align the electronic device 12 to the wireless charger 70 and bias the electronic device 12 (via the extensions 284) toward the wireless charger 70 (and thus toward the wireless charger holder 274, as described further herein) and/or toward the first side wall 254. Specifically, the aligning mechanism 280 positions the electronic device 12 within the electronic device holder 250 such that either the front face 2 or the back face 4 of the electronic device 12 and the wireless charger 70 (or the inner surface of the first side wall 254) are flush with each other (as shown in FIGS. 33-34). The aligning mechanism 280, along with the edge stabilizer 260, also helps support and secure the electronic device 12 within the electronic device holder 250 in both the landscape orientation 16 and the portrait orientation 18.

The aligning mechanism 280 may include the various features and components of the aligning mechanism 72 (as described further herein) (and vice versa)), depending on the desired configuration. The aligning mechanism 280 may also be used without the wireless charger 70 to further secure the electronic device 12 within the electronic device holder 250.

As shown in FIGS. 33-34, the aligning mechanism 280 is positioned directly opposite the wireless charger 70 across the lateral width of the electronic device holder 250 such that the electronic device 12 is sandwiched and secured upright between the aligning mechanism 280 and the wireless charger 70. When the aligning mechanism 280 aligns the electronic device 12 to create flush contact between the electronic device 12 and the wireless charger 70, the front and back faces 2, 4 of the electronic device 12 and the wireless charger 70 are substantially parallel, as shown in FIGS. 33-34.

The aligning mechanism 280 and the wireless charger 70 extend from and are positioned opposite sides of the electronic device holder 250 (and thus opposite sides of the electronic device 12) such that the electronic device 12 is sandwiched between the aligning mechanism 280 and the wireless charger 70. For example, the aligning mechanism 280 is positioned along and extends from the second side wall 256, while the wireless charger 70 is positioned along the first side wall 254. Accordingly, the aligning mechanism 280 extends along and directly abuts against one of the front face 2 or the back face 4 of the electronic device 12, while other of the front face 2 or the back face 4 faces the wireless charger 70. The aligning mechanism 280 presses the electronic device 12 against either the wireless charger 70 (or the wireless charger holder 274) or the first side wall 254. The aligning mechanism 280 is positioned above the protrusions 262 in order to contact the electronic device 12 in either orientation.

As shown in FIGS. 33-36, the aligning mechanism 280 includes a base 282 and at least one (preferably a plurality of) knob, rib, movable plastic “arm,” protrusion, bump, or extension 284. The base 282 attaches to the second side wall 256 of the electronic device holder 250. The extension 284 extends from the base 282 toward the first side wall 254 and is flexible in order to adapt to the specific size of and secure a variety of different electronic devices 12 (and their respective cases) with a variety of different sizes (in particular thicknesses). The extensions 284 extend downwardly at an angle from the base 282 and may include a vertical lip at the end that extends along a portion of the vertical height of the electronic device 12 in order to have more surface contact to and a stronger grip on the electronic device 12.

The aligning mechanism 280 may include any number of extensions 284, depending on the desired configuration and in order to provide multiple contact points along the electronic device 12, regardless of its orientation. As shown in FIGS. 39-40, the aligning mechanism 280 includes three extensions 284 that are spaced apart along the longitudinal length of the base 282 (i.e., along the length of the electronic device holder 250) and independently movable relative to the base 282. As shown in FIGS. 35-36, all three of the extensions 284 contact and support the front face 2 of the electronic device 12 when in the landscape orientation 16. As shown in FIGS. 39-40, at least the middle extension 284 and potentially at least a portion of each of the side extensions 284 (that overhang the gap 268 between the two protrusions 262), depending on the size of the electronic device 12), contact and support the front face 2 of the electronic device 12 when in the portrait orientation 18. Accordingly, at least one of the extensions 284 (e.g., the middle extension 284) is at least partially longitudinally aligned with the gap 268 between the two protrusions 262 in order to secure the electronic device 12 when positioned in the portrait orientation 18.

The aligning mechanism 280 (including both the base 282 and the extensions 284) may be constructed or formed as an integral, single part. Accordingly, the aligning mechanism 280 comprises a single unitary component that cannot be separated without destruction. The aligning mechanism may be constructed out of a variety of different flexible materials, including but not limited to rubber.

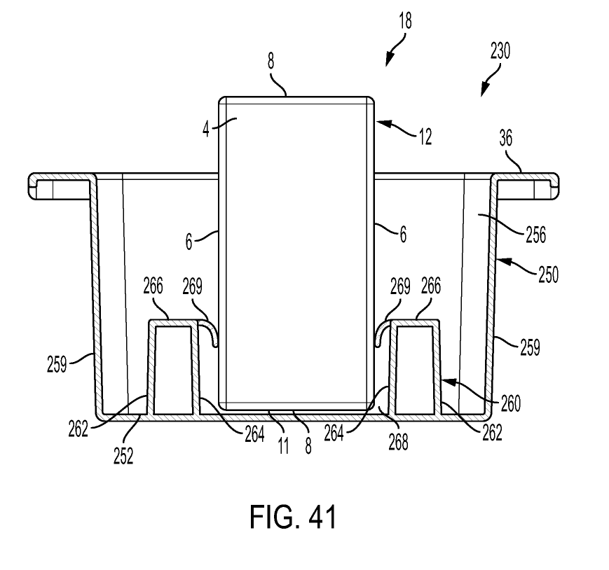

According to one embodiment as shown in FIG. 41, each of the protrusions 262 includes an inner flange 269 that extends into the gap 268 between the protrusions 262 in order to further stabilize the electronic device 12 when in the portrait orientation 18. The inner flanges 269 are flexible or bendable extensions that conform to the specific shape and size of the electronic device 12. In particular, when the electronic device 12 is positioned within the electronic device holder 250 in the portrait orientation 18, the inner flanges 269 each directly abut opposite long edges 6 of the electronic device 12, which centers and secures the electronic device 12 along the longitudinal length of the electronic device holder 250 and prevents longitudinal movement of the electronic device 12 relative to the electronic device holder 250. The inner flange 269 may extend from the top surfaces 266 and/or the inner side surfaces 264 of the protrusions 262. The inner flange 269 may be constructed out of a variety of different flexible materials, including but not limited to rubber.

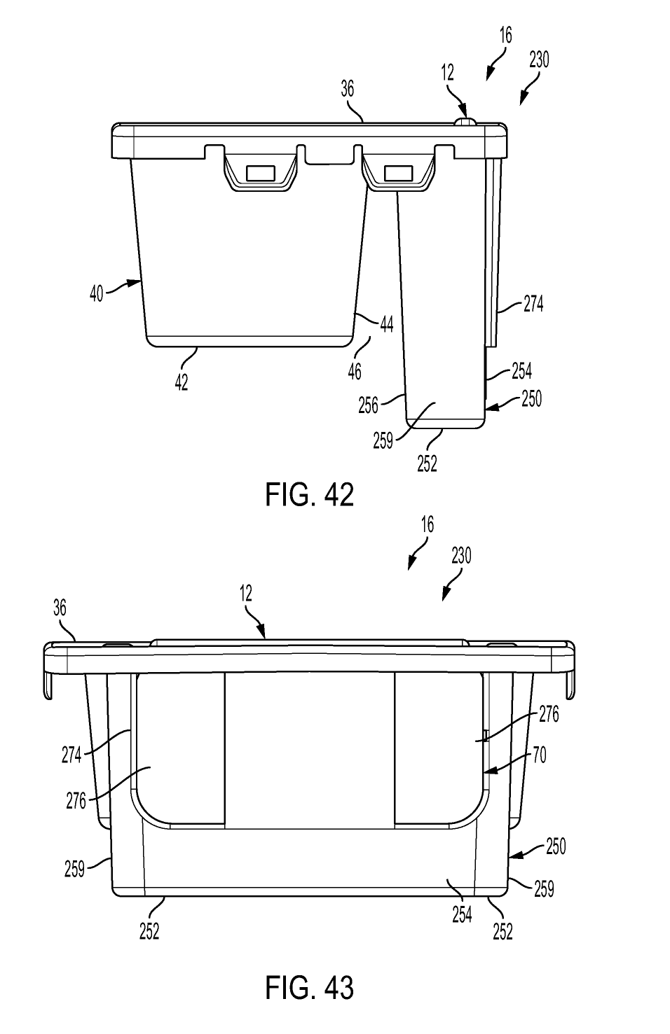

As shown in FIGS. 42-43, the electronic device holder 250 includes a wireless charger pocket, storage area, or holder 274 that is configured to secure the wireless charger 70 in a position such that the electronic device 12 can be charged by the wireless charger 70 in both the landscape orientation 16 and the portrait orientation 18. The wireless charger holder 274 is a part of, integrated into, positioned along, and at least partially recessed within the first side wall 254 of the electronic device holder 250 in order to provide an area to secure the wireless charger 70. The wireless charger holder 274 is configured to position and hold the wireless charger 70 in the desired position relative to the rest of the electronic device holder 250 (as described further herein). Accordingly, the position of the wireless charger 70 referred to herein may also apply to the position of the wireless charger holder 274, unless otherwise specified. For example, the wireless charger holder 274 positions the wireless charger 70 at least partially above the top surfaces 266 of the protrusions 262 and at least partially aligned longitudinally above the gap 268 between the protrusions 262.

As shown in FIG. 43, the wireless charger holder 274 may include or define at least one through-hole, opening, or aperture 276 that is configured to receive the wireless charger 70 such that the wireless charger holder 274 (and therefore to the entire electronic device holder 250) can attach to the wireless charger 70.

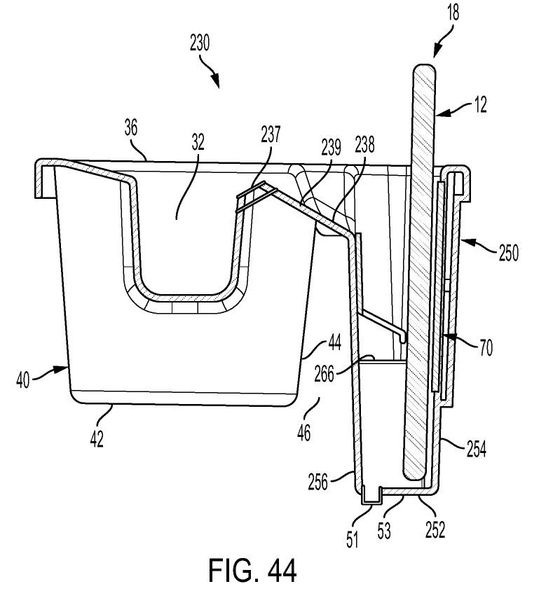

According to one embodiment as shown in FIG. 44, the electronic device holder 250 may include various features (i.e., anti-drip edges or surfaces) within or near the electronic device holder 250 in order to prevent the electronic device 12 from getting wet. The various “anti-drip” features described herein may be used in conjunction with each other or separately, depending on the desired configuration.

In order to prevent liquid from moving toward the electronic device 12, at least a portion of the angled top wall 238 may extend downwardly toward the respective side walls 44 of the cup holders 40. For example, the angled top wall 238 may include a first portion 237 (e.g., a drip surface) and a second portion 239 that are angled downward in opposite directions. The first portion 237 is angled downward from a center portion of the angled top wall 238 to the cup holders 40 (or to the gap 32) in order to prevent liquid from moving out of the cup holders 40 and toward the electronic device holder 250 and to instead direct liquid back into the cup holders 40 (or the gap 32). The second portion 239 is angled downward from the center portion of the angled top wall 238 to the electronic device holder 250 in order to still allow the electronic device 12 to be easily inserted into and removed from the electronic device holder 250 (as described further herein). Accordingly, the center portion of the angled top wall 238 (i.e., the portion between the first portion 237 and the second portion 239) may be the highest portion of the angled top wall 238.

Alternatively or additionally, the bottom wall 252 includes a lower portion 51 and an upper portion 53, as described further herein. Alternatively or additionally, the angled top wall 238 may include at least one hole, groove, or drip collector along its width in order to prevent liquid from moving toward the electronic device 12.

The vertical height of the electronic device holder 250 is described further herein in regard to the electronic device holder 50. However, according to one embodiment, the bottom wall 252 of the electronic device holder 250 may be lower (and further from the top wall 36) than the bottom wall 42 of the cup holders 40. Accordingly, the vertical height of the electronic device holder 250 may be greater than less than the vertical height of the cup holders 40.

The electronic devices holder 250 may include the various features and components of the electronic device holder 50 (and vice versa).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A cup holder structure comprising:
two cup holders that are aligned with each other along a longitudinal direction, each of the two cup holders including respective cup holder side walls and defining respective cup holder cavities; and
an electronic device holder extending along the longitudinal direction next to and proximate to both of the two cup holders, the electronic device holder including an electronic device holder side wall and defining an electronic device holder cavity;
wherein the electronic device holder cavity is separated from the cup holder cavities by at least one of the electronic device holder side wall or the cup holder side walls.

2. The cup holder structure of claim 1, wherein the electronic device holder is configured to secure an electronic device in either a portrait orientation or a landscape orientation.

3. The cup holder structure of claim 2, wherein the electronic device holder includes a bottom wall that extends along a short edge of the electronic device when the electronic device is in the portrait orientation and extends along a long edge of the electronic device when the electronic device is in the landscape orientation.

4. The cup holder structure of claim 2, wherein the electronic device holder includes a bottom wall and an electronic device edge stabilizer, wherein the edge stabilizer includes a protrusion that has a top surface that is positioned above the bottom wall by a vertical distance;
wherein the bottom wall extends along a short edge of the electronic device when the electronic device is in the portrait orientation; and
wherein the top surface of the protrusion extends along at least a portion of a long edge of the electronic device such that the long edge of the electronic device is spaced above the bottom wall by the vertical distance when the electronic device is in the landscape orientation.

5. The cup holder structure of claim 4, wherein the edge stabilizer includes two protrusions that are spaced apart from each other in the longitudinal direction by a gap that is configured to receive at least a portion of the electronic device in the portrait orientation.

6. The cup holder structure of claim 5, wherein each of the protrusions includes an inner flange that extends into the gap.

7. The cup holder structure of claim 2, wherein the electronic device holder includes a wireless charger holder that is configured to secure a wireless charger in a position such that the electronic device can be charged by the wireless charger in both the landscape orientation and the portrait orientation.

8. The cup holder structure of claim 7, wherein the electronic device holder includes an aligning mechanism configured to bias the electronic device toward the wireless charger holder.

9. The cup holder structure of claim 8, wherein the aligning mechanism includes a plurality of extensions, wherein the aligning mechanism is formed as a single, integral part.

10. The cup holder structure of claim 7, wherein the aligning mechanism is constructed out of a flexible rubber.

11. The cup holder structure of claim 7, wherein the electronic device holder includes a first side wall and a second side wall, wherein the electronic device holder side wall is the second side wall, wherein the second side wall is closer to the two cup holders than the first side wall, wherein the wireless charger holder is positioned along the first side wall.

12. The cup holder structure of claim 11, wherein the electronic device holder includes an aligning mechanism configured to bias the electronic device toward the wireless charger holder, and wherein the aligning mechanism extends from the second side wall.

13. The cup holder structure of claim 7, wherein the wireless charger holder includes an aperture that is configured to receive the wireless charger such that the wireless charger holder attaches to the wireless charger.

14. The cup holder structure of claim 1, further comprising an angled top wall that extends between a top of the electronic device holder and a top of the two cup holders, wherein the angled top wall extends downwardly from the top of the two cup holders to the top of the electronic device holder.

15. The cup holder structure of claim 1, further comprising an opening that extends between one of the two cup holders and the electronic device holder.

16. The cup holder structure of claim 15, wherein the opening is positioned at a longitudinal end of the electronic device holder.

17. The cup holder structure of claim 1, further comprising a top wall that extends between the respective cup holder side walls of the two cup holders and the electronic device holder side wall of the electronic device holder.

18. The cup holder structure of claim 17, wherein the top wall extends downwardly at an oblique angle from the respective cup holder side walls of the two cup holders to the electronic device holder side wall of the electronic device holder.

19. The cup holder structure of claim 17, wherein at least a portion of the top wall extends downwardly toward the respective cup holder side walls of the two cup holders.

20. The cup holder structure of claim 1, where the electronic device holder includes a bottom wall that includes an upper portion and a lower portion, wherein the upper portion is vertically higher than the lower portion.
